(19) United States
(12) Patent Application Publication
(10) Pub. No.: US 2014/0299162 A1
(43) Pub. Date: Oct. 9, 2014

(54) Hyperbaric Methods and Systems for Surface Treatment, Cleaning, and Drying: Thin Liquid H-CNX

(71) Applicant: Advanced Wet Technologies GmbH, Huefingen (DE)

(72) Inventor: Richard W. Plavidal, Milpitas, CA (US)

(21) Appl. No.: 14/308,666

(22) Filed: Jun. 18, 2014

Related U.S. Application Data
(63) Continuation-in-part of application No. 13/888,338, filed on May 6, 2013.
(60) Provisional application No. 61/836,653, filed on Jun. 18, 2013.
(60) Provisional application No. 61/643,328, filed on May 6, 2012.
(60) Provisional application No. 61/643,329, filed on May 6, 2012.
(60) Provisional application No. 61/643,330, filed on May 6, 2012.
(60) Provisional application No. 61/643,332, filed on May 6, 2012.

(51) Int. Cl. B08B 7/00; B08B 3/04; B08B 7/04

(52) U.S. Cl. CPC B08B 7/0021; B08B 7/04; B08B 3/04
USPC 134/30; 134/34

(57) ABSTRACT

Objects with complex surface profiles can be cleaned effectively using hyperbaric pressures. A high temperature high pressure liquid or vapor can be introduced to a sealed chamber containing an object to be cleaned, forming a thin liquid layer on the object. The pressure in the sealed chamber can be quickly reduced, evaporating the thin liquid layer, which can remove surface contaminants from the object. The process can be repeated until the object is cleaned.

This application claims priority from provisional patent application Ser. No. 61/836,653, filed on Jun. 18, 2013, entitled “Hyperbaric Methods and Systems for Surface Treatment, Cleaning, and Drying: Thin Liquid H-CNX”, which is hereby incorporated by reference in its entirety.

This application is a continuation in part of application Ser. No. 13/888,338, filed on May 6, 2013, entitled “Hyperbaric Methods and Systems for Surface Treatment, Cleaning, and Drying”, which claims priority from U.S. provisional patent application Ser. No. 61/643,328, filed on May 6/2012, entitled “Hyperbaric Methods and Systems for Surface Treatment, Cleaning, and Drying”, from U.S. provisional patent application Ser. No. 61/643,329, filed on May 6, 2012, entitled “Hyperbaric Methods and Systems for Surface Treatment, Cleaning, and Drying”, from U.S. provisional patent application Ser. No. 61/643,330, filed on May 6, 2012, entitled “Hyperbaric Methods and Systems for Surface Treatment, Cleaning, and Drying”, from U.S. provisional patent application Ser. No. 61/643,332, filed on May 6, 2012, entitled “Hyperbaric Methods and Systems for Surface Treatment, Cleaning, and Drying”, which are incorporated herein by reference.

This application is related to application Ser. No. 13/733,119, filed on Jan. 2, 2013, entitled “Methods and systems for cleaning for cyclic nucleation transport (CNX)”, which claims priority from provisional patent application Ser. No. 61/582,482, filed on Jan. 2, 2012, entitled “Methods and systems for cleaning”, which are hereby incorporated by reference in their entirety.

### BACKGROUND

Parts or devices with complex shapes pose a special challenge for surface treatment and cleaning due to small openings, internal dead spaces, blind holes and other hard to access places within the part. Traditional sprays and sonic agitation cannot access these areas effectively and even if they could it would be difficult or impossible to remove chemical byproducts, loosened debris and contaminated cleaning solutions from these parts. Even complex manifold flow connections cannot effectively flush contamination from trapped areas and dead spaces within some parts.

### SUMMARY OF THE DESCRIPTION

In some embodiments, a hyperbaric cleaning process is disclosed, including forming a thin liquid layer on an object, and evaporating the thin liquid layer. The thin liquid layer can be condensed from a saturated vapor or a superheated vapor, and thus can be easily evaporated when the pressure drops. The thin liquid layer can formed by spraying a saturated liquid on the object. The evaporation process can remove particulates which adhere to the object surface, potentially cleaning the object. The process can be repeated until the object is cleaned.

### BRIEF DESCRIPTION OF THE DRAWINGS

FIGS. 1A-1B illustrate exemplary regimes of operation according to some embodiments.

FIGS. 2A-2B illustrate configurations for a hyperbaric cleaning process according to some embodiments.

FIGS. 3A-3B illustrate a cleaning process utilizing hyperbaric vapor pressure according to some embodiments.

FIG. 4 illustrates an exemplary system configuration for cleaning and/or drying an object according to some embodiments.

FIGS. 5A-5B illustrate another exemplary cleaning and drying process utilizing hyperbaric vapor pressure according to some embodiments.

FIG. 6 illustrates another exemplary system configuration for cleaning and/or drying an object according to some embodiments.

FIGS. 7A-7B illustrate exemplary flow charts for a hyperbaric cleaning process according to some embodiments.

FIGS. 8A-8C illustrate an exemplary cleaning and drying process utilizing hyperbaric vapor pressure according to some embodiments.

FIG. 9 illustrates another exemplary flow chart for a hyperbaric drying process according to some embodiments.

FIG. 10 illustrates a schematic layout of a thin liquid hyperbaric system according to some embodiments.

FIGS. 11A-11B illustrate a hyperbaric cleaning process according to some embodiments.

FIGS. 12A-12B illustrate a hyperbaric cleaning process according to some embodiments.

FIG. 13 illustrates a flow chart for a hyperbaric cleaning process according to some embodiments.

### DETAILED DESCRIPTION OF THE EMBODIMENTS

A cyclic nucleation transport (CNX) process can be used to clean objects with complex shapes. An object can be submerged in a liquid, and the vapor pressure can cycled between a low pressure level, e.g., vacuum level, and a high pressure level, e.g., higher than the low pressure level. At the low pressure, the liquid can start to boil, generating bubbles. The process conditions are preferably controlled so that the bubbles are generated at the surface of an object. At the high pressure, the generated bubbles can be terminated, e.g., collapsed, which can impart energy to dislodge surface contaminates, cleaning the object.

CNX process can grow and collapse vapor bubbles which would displace fluids and dislodge contamination from hidden surfaces. Furthermore the nucleation process is independent of boundary layers and geometries which would otherwise block any cleaning agitation or displacement. In CNX process, all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the object surface.

A hyperbaric cyclic nucleation transport (H-CNX) process can be used, in which the pressure is cycled from a pressure higher than atmospheric pressure. The higher pressure can be accompanied by higher temperature, which provides additional benefits of more efficient cleaning and cheaper liquid medium. The cycling can be performed by varying pressure, for example, from a pressure equal or higher than the boiling pressure of the liquid (and higher than atmospheric pressure in some embodiments) to a pressure lower or equal than the boiling pressure of the liquid (which can be higher or lower than atmospheric pressure).

In some embodiments, cyclic nucleation technology with hyperbaric pressure can be used for surface processing, cleaning and drying an object. Hyperbaric pressure process can significantly simplify the cleaning and drying equipment, for example, by eliminating vacuum pumps or power during the cyclic process. In addition, hyperbaric pressure process can extend the temperature ranges, which can lead to faster reaction rates, increasing processing speed and cleaning effectiveness. Further, the consumables can be less expensive and more environment friendly, for example, water and steam at elevated temperatures can be used instead of highly reactive chemicals.

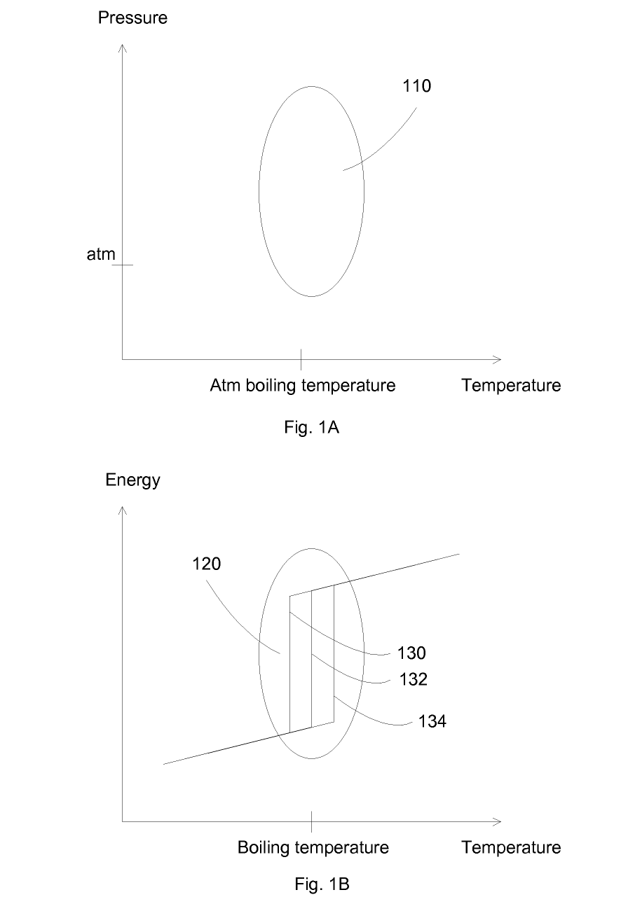

FIGS. 1A-1B illustrate exemplary regimes of operation according to some embodiments. In FIG. 1A, a temperature-pressure curve is showed, illustrating the exemplary operation regime 110 of the present invention, which is preferably above the atmospheric pressure, and the corresponding boiling temperature, i.e., boiling temperature at atmospheric pressure. The process regime preferably comprises regions with higher pressure than the atmospheric pressure, and at temperatures higher than the boiling temperature at atmospheric pressure. In FIG. 1B, temperature-energy curves are showed, illustrating the exemplary operation regime 120 of the present invention, which is preferably surrounding the transition temperatures 130-134, corresponded to different pressures. The transition temperature is generally the boiling temperature, for example, 100° C. at atmospheric pressure for water, and higher or lower temperatures at higher or lower pressures, respectively. In some embodiments, the present invention discloses cyclic hyperbaric process, with the operating regime surrounding the transition temperature at pressure higher than the atmospheric pressure.

The hyperbaric CNX (H-CNX) process can provide significant benefits, including expanded temperature ranges, e.g., higher temperatures are associated with faster reaction rates which increases part processing speed and cleaning effectiveness; greater use of pure water and steam at elevated temperatures to clean without the use of dangerous, expensive, or environmentally unfriendly chemicals; more efficient drying, which can be aided by the elevated temperatures as well as the ability for expanding vapor bubbles to rapidly displace trapped liquid on the surfaces of a part; elimination of vacuum pumps since pressure can be released to atmospheric pressure; sterilization which may be accomplished in-situ with the cleaning process since autoclave conditions can be achieved as a natural consequence of H-CNX processing; usage of DI water, which at high temperature and pressure can offer superior cleaning and degreasing without solvents; simple design; and in-situ drying using saturated or superheated steam.

In CNX process, the cycling of pressure can generate and terminate bubbles. For example, a liquid at a low vapor pressure can start boiling, e.g., generating bubbles, at a temperature lower than the boiling temperature of the liquid. When the vapor pressure increases, the bubbles can be terminated or collapse. The bubbles act to displace and transport chemicals, contamination, particles and debris to and from surfaces. The cycling of bubbles can gradually providing energy from the liquid medium to the object surface for cleaning.

In H-CNX process, a liquid medium can be brought to a state having high internal energy, such as providing thermal energy to a pressure above the atmospheric pressure and a temperature above the boiling temperature at atmospheric pressure (but below the boiling temperature of the pressure of the liquid). The energy can be released in such a way to cyclically generate and terminate bubbles at the object surface, processing and cleaning the object surface with the bubble energy. For example, by temporarily releasing the pressure of the liquid to below the boiling point, e.g., atmospheric pressure by opening a relief valve, the bubbles are generated. The pressure release process can be performed without actively acting on the temperature of the liquid, thus the liquid temperature can be unchanged or slightly changed, depending on the equipment and process. Then the pressure release is terminated, and equilibrium can be re-established. For example, the relief valve is closed, and vapor pressure is built up to equilibrium. The equilibrium point is preferably above the boiling point, e.g., the liquid pressure is higher than the boiling pressure of the liquid temperature, and thus the bubbles are terminated, acting to bring fresh fluid and energy to clean the object surface, for example, by releasing the energy to the particulates adhering to the object surface. The process can be repeated until the object is cleaned, or until the internal energy is no longer adequate to perform the pressure cycling. In some embodiments, additional energy can be provided.

The H-CNX process can simplify the equipment and process, for example, with energy applied only at the beginning to provide high internal energy to the liquid medium. The subsequent cyclic nucleation transport action can be performed by simply toggling the relief valve at a frequency optimal for the cleaning process.

For example, an object can be disposed in a liquid medium having high internal energy, and then the internal energy is reduced to form bubbles in the liquid medium. At the beginning, the bubbles tend to nucleate at the object surface. With more energy released, the bubbles can form in the liquid medium. The bubbles are then terminated when at the surface, and during the collapse of the bubbles, energy can be provided to the object surface, removing any adhering contamination or residue. The cycling of bubbles, generation and termination, can act to clean the object surface, even at hard to reach places. The high internal energy can be in the form of high temperature, high pressure liquid, and the energy released can be in the form of pressure released, reducing the internal energy of the liquid.

In a H-CNX process, an object can be partially or totally submerged in a liquid medium in a sealed container. The liquid can partially or totally fill the container. The liquid medium has a vapor phase pressure above the atmospheric pressure. The liquid medium is not boiling or not at an onset of boiling, meaning there is no bubble formation within the liquid, either at the object surface or at the liquid medium. The pressure within the sealed container is decreased, for example, by opening a relief valve to the atmosphere. Since the liquid medium is at higher vapor pressure, reducing the pressure can lead to bubble formation, e.g., onset of boiling with bubbles nucleated at the object surface. The pressure within the sealed container is then increased, for example, preferably by closing the relief valve. The bubbles are then terminated as the pressure stabilizes at the vapor pressure. The pressure cycling is repeated, with the pressure cycles at above atmospheric pressure. The cycling of bubbles, e.g., repeated sequence of bubble formation and termination, can lead to a chemical processing or cleaning of the object surface.

In some embodiments, the present invention discloses a hyperbaric cyclic nucleation process, in which the object may not be submerged in a liquid. Instead the object may be covered at least partially with a thin layer of liquid as a wetted surface. Thus, the release of pressure may be fast since there can be no unwanted nucleation in bulk liquid but all bubble formation occurs at surfaces. The thin liquid layer may be applied to the object by prior submerging, by spray, or by condensing saturated vapors onto surfaces. In either case, the thin liquid may be subject to CNX which will cause rapid evaporation and expulsion from surfaces. This rapid expulsion of vapor will carry with it unwanted reaction byproducts and other debris from the surface of the object.

In some embodiments thin liquid or vapor condensate may be used to treat surfaces where immersion processes would be less controlled, damaging, or produce unwanted side effects.

In some embodiments, the thin liquid hyperbaric nucleation process can include exposing an object to hyperbaric liquid and/or vapor, followed by removing the hyperbaric liquid and/or vapor. The process can be repeated. For example, a liquid layer having high internal energy can be formed on the surface of an object, for example, by exposing the object to a vapor medium having high internal energy to form a condense liquid layer, or by spraying the object with a liquid medium having high internal energy. The internal energy can be reduced to phase change the liquid layer, e.g., converting the liquid layer into vapor form and expunged from the object surface. During the phase change conversion, energy can be provided to the object surface, removing any adhering contamination or residue. The cycling of thin liquid layers, forming and vaporizing, can act to clean the object surface, even at hard to reach places. The high internal energy can be in the form of high temperature, high pressure liquid, and the energy released can be in the form of pressure released, reducing the internal energy of the liquid.

In some embodiments, a liquid or a vapor can be provided to an object in a sealed container. The liquid can be sprayed on the object. The vapor can be introduced to the sealed container, to be condensed on the object surface. The liquid and/or vapor can have a vapor phase pressure above the atmospheric pressure. The pressure within the sealed container is decreased, for example, by opening a relief valve to the atmosphere. By quickly decreasing the pressure of the container, the liquid and/or vapor can be removed from the object surface, potentially removing any contaminates at the object surface.

The pressure within the sealed container is then increased, for example, by re-introducing the liquid and/or vapor. The repeating of pressure cycling, e.g., by cycling the introduction and removal of liquid and/or vapor, can lead to a chemical processing or cleaning of the object surface.

In some embodiments, the present invention discloses methods and apparatuses utilizing high energy fluid, such as saturated or superheated steam or water, as the medium for cleaning and drying. Steam can be reduced from a hyperbaric saturated steam (for example, at 5 bar pressure and 160° C.) to atmospheric steam (for example, at 1 bar and 130° C.). High pressure to low pressure can be achieved by adiabatic expansion, for example, through a relief valve. Low pressure to high pressure can be achieved by vaporizing liquid, or by providing a pressurized gas or vapor. The outlet of the relief valve can be released to the atmosphere ambient, a special vacuum condenser pressure relief container, where it can be recycled or properly disposed.

Saturated steam is steam that is in equilibrium with heated water (e.g., saturated water) at the same pressure. For example, at atmospheric pressure, water is boiled at 100C, generating saturated steam and saturated water. If saturated steam is reduced in temperature while keeping the same pressure, it will condense to produce water droplets. For example, saturated water contains as much thermal energy as it can without boiling. Conversely a saturated vapor contains as little thermal energy as it can without condensing.

Superheated steam is steam at a temperature higher than water's boiling point. If saturated steam is heated at constant pressure, its temperature will also remain constant as the steam becomes dry saturated steam. Continued heating will then generate superheated steam.

Superheated water is liquid water under pressure at temperatures between the usual boiling point (100° C.) and the critical temperature (374° C.). It is also known as subcritical water and pressurized hot water. Superheated water can be stable under high pressure, for example, by heating in a sealed vessel with a headspace, where the liquid water is in equilibrium with water vapor at the saturated vapor pressure. This is different with unstable superheating, which refers to water at atmospheric pressure above its normal boiling point and which has not boiled due to a lack of nucleation sites.

In some embodiments, the present invention discloses methods and apparatuses for cleaning and optionally drying objects, including coating or wetting the object surface with a thin liquid layer condensed from a high pressure and high temperature vapor. When the thin liquid layer is evaporated, e.g., by rapidly releasing the pressure of the container in which the object is placed, energy can be transferred to the object surface. Rapidly expanding vapors can displace and vaporize the liquid layer on the object surface, effectively cleaning the object. A complete vaporization process can also dry the object, for example, by a very thin liquid layer or by a high temperature high pressure liquid layer.

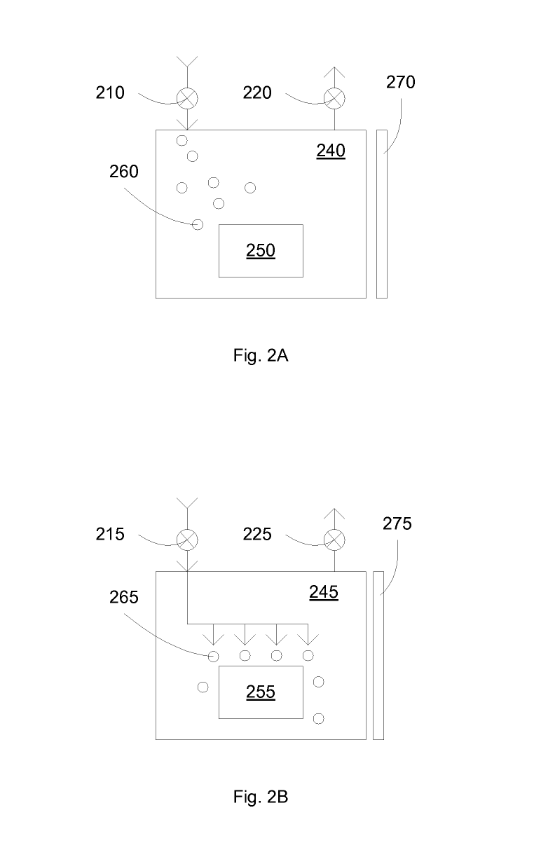

FIGS. 2A-2B illustrate configurations for a hyperbaric cleaning process according to some embodiments. In FIG. 2A, an object 250 is disposed in a chamber 240. Valve 210 can be coupled to a high temperature high pressure vapor reservoir, such as a saturated or superheated vapor reservoir. Valve 220 can be coupled to the ambient or to a drain reservoir. In operation, valve 210 is open to supply the chamber 240 with high pressure and temperature vapor 260 from the high temperature high pressure vapor reservoir. Valve 220 is closed to maintain high pressure within the chamber 240. The vapor 260 has pressure at or above the boiling pressure corresponded to its liquid temperature, e.g., having temperature-pressure state at or above the boiling curve of the liquid.

During the exposure to the high energy vapor 260, the vapor 260 can be condensed on the object 250. The chamber can optionally include a heater assembly 270 to reduce or prevent condensation at the walls of the chamber 240, together with maintaining the high energy state of the liquid 260. The object 250 can be exposed to the high energy vapor 260 to form a thin liquid layer on the object surface. The thin liquid layer can be continuous, e.g., forming a continuous coating on the object surface. The thin liquid layer can be discontinuous, e.g., leaving some surface areas without liquid or with liquid droplets instead of a layer of liquid. The thin liquid layer can include only liquid droplets on the object surface.

Valve 210 can then be close. Valve 220 can be open to release the vapor 260 to the ambient, e.g., atmospheric environment, or to a drain reservoir. The liquid layer or liquid droplets adhering to the object can be evaporated and released to the ambient. The pressure release can also generate a fluid flow from all surfaces, thus can expel any liquid droplets from all surfaces and trapped spaces on the object or in the chamber, especially droplets at the vicinity of the outlet.

In some embodiments, the pressure release can provide an effective cleaning of the object, since the evaporation of the liquid layer or liquid droplets at the object surface can impart energy to the adhered contaminants, dislodging the contaminants from the object surface. Optionally, the pressure release can also dry the object, by removing liquid on the object surface.

In FIG. 2B, an object 255 is disposed in a chamber 245. Valve 215 can be coupled to a high temperature high pressure liquid reservoir, such as a saturated or superheated liquid reservoir. Valve 225 can be coupled to the ambient or to a drain reservoir. In operation, valve 215 is open to supply the chamber 245 with high pressure and temperature liquid 265 from the high temperature high pressure liquid reservoir. Valve 225 is closed to maintain high pressure within the chamber 245. The liquid 265 has pressure at or above the boiling pressure corresponded to its liquid temperature, e.g., having temperature-pressure state at or above the boiling curve of the liquid.

During the exposure to the high energy liquid 265, the liquid 265 can form a coating on the object 255. The chamber can optionally include a heater assembly 275 to reduce or prevent condensation at the walls of the chamber 245, together with maintaining the high energy state of the liquid 265. The coating, formed by the liquid flow 265, can be continuous or discontinuous.

Valve 215 can then be close. Valve 225 can be open to reduce the pressure in the chamber 245, such as by releasing the vapor in the chamber 245 to the ambient, e.g., atmospheric environment, or to a drain reservoir. The liquid layer or liquid droplets adhering to the object can be evaporated and released to the ambient.

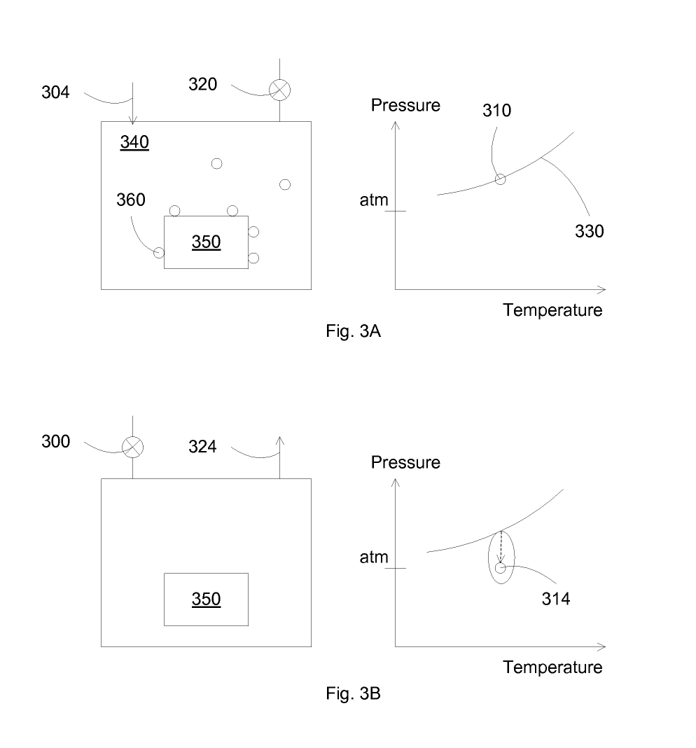

FIGS. 3A-3B illustrate a cleaning process utilizing hyperbaric vapor pressure according to some embodiments. In FIG. 3A, an object 350 is disposed in a chamber 340, which accepts high pressure and temperature vapor 360 from inlet 304. Valve 320 is closed to maintain high pressure within the chamber 340. The vapor 360 has pressure at or above the boiling pressure corresponded to its liquid temperature, e.g., having temperature-pressure state 310 at, below, or above the boiling curve 330. For example, saturated steam can be at the boiling curve, while superheated steam can have pressure above the boiling curve pressure. In addition, the pressure of the vapor 360 is preferably above atmospheric pressure. For example, the vapor 360 can be water vapor, e.g., steam, at pressure 5 bars and temperature 160° C. During the exposure to the high energy vapor 360, the object can be sterilized due to the high temperature vapor. The chamber is shown to be without any liquid, but in some embodiments, liquid can be present and also liquid droplets may be present at the surface of the object. Optional heaters can be provided to heat the chamber walls, preventing or reducing condensation on the chamber walls.

In FIG. 3B, inlet 304 is close (shown by a close valve 300), and valve 320 is quickly open (shown by valve state 324), releasing the vapor 360 to the ambient, e.g., atmospheric environment. The vapor state 314 can be dropped, for example, to a pressure below the boiling curve, and any liquid droplets adhering to the object can be evaporated and released to the ambient. In addition, the pressure release can also generate a fluid flow from all surfaces, thus can expel any liquid droplets from all surfaces and trapped spaces on the object or in the chamber, especially droplets at the vicinity of the outlet. The process can be repeated until the object is cleaned.

In some embodiments, the pressure release can provide an effective cleaning and optionally drying of the object, since some or all liquid vapor can be quickly evaporated when returning to atmospheric pressure, and liquid droplets can be pushed out of the chamber. The evaporation process can remove contaminants from the object surface.

Other configurations can be used, such as inlet 304 is configured to spray a high temperature high pressure liquid (such as a saturated liquid or superheated liquid), instead of a high temperature high pressure vapor. The vapor or liquid from inlet 304 can provide a thin liquid coating, either by condensation (from the vapor) or by wetting (from the liquid).

The above explanation is oversimplified, and is not meant to limit the scope and validity of the present invention, which is defined by the enclosed claims.

In some embodiments, the vapor medium can be supplied to the chamber through a reservoir. The reservoir can be heated to maintain a constant supply of liquid/vapor at the proper pressure, e.g., hyperbaric pressure, to the chamber.

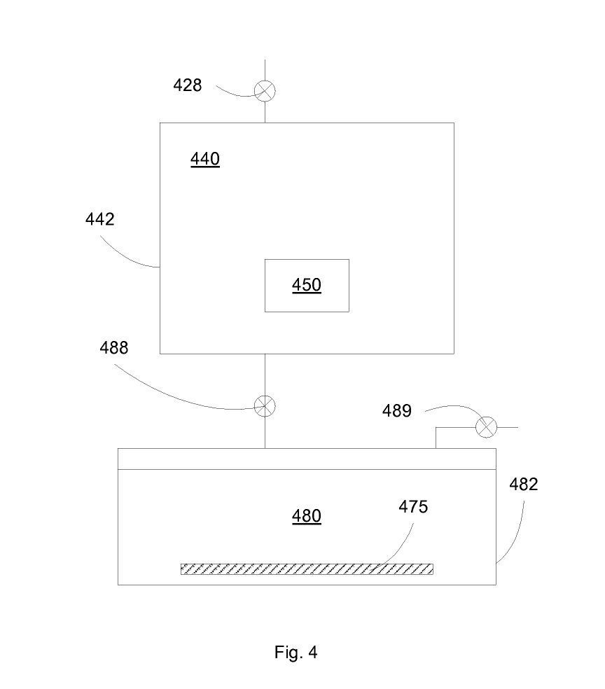

FIG. 4 illustrates an exemplary system configuration for cleaning and/or drying an object according to some embodiments. A reservoir 482 can supply high energy vapor to a chamber 442 through a valve 488. Heater 475 can be used to heat the liquid 480 to a pressure above atmospheric pressure. Heater 475 can be constantly heated to maintain the proper temperature and pressure for the liquid 480. Valve 489 can be used to supply pressurized gas, vapor or liquid to the reservoir. Valve 488 can be open to deliver the heated vapor to the chamber 442, surrounding the object 450 within vapor 440. A relief valve 428 is included to release the vapor. Optional heaters can be provided to heat the chamber walls, preventing or reducing condensation on the chamber walls.

Other configurations can be used, such as valve 488 can be coupled to the liquid portion 480, and can be configured to spray a high temperature high pressure liquid (such as a saturated liquid or superheated liquid) on the object 450. The vapor or liquid from inlet 488 can provide a thin liquid coating, either by condensation (from the vapor) or by wetting (from the liquid).

In some embodiments, the present invention discloses a heated and pressurized process fluid supply reservoir is used to deliver hot vapor or steam under controlled pressure to the process chamber. The present invention further discloses a hyperbaric process chamber capable of receiving either liquid or vapor under pressure from the supply reservoir, and capable of releasing vapor under pressure from the process chamber to begin the cyclic cleaning process. The hyperbaric process chamber can be capable of releasing liquid under pressure from the process chamber to drain the chamber. The present invention further discloses the use of a controlled process chamber pressure release to nucleate and expand vapor under pressure so that droplets of liquid remaining on or in the part after chamber has been drained will be rapidly displaced and vaporized.

In some embodiments, an object is partially or totally submerged in a gaseous medium in a sealed container. The gas can partially or totally fill the container. There can be some liquid in the container, or the container can be filled with gaseous medium. The gas medium has a vapor phase pressure above the atmospheric pressure. The pressure within the sealed container is decreased, for example, by opening a relief valve to the atmosphere. The pressure cycling is repeated, with the pressure cycles at above atmospheric pressure. The gaseous medium cycling can lead to surface processing and/or cleaning and drying of the object.

In some embodiments, the chamber pressure can be above the boiling pressure at the liquid temperature. For example, a saturated steam, which has pressure at the boiling pressure at the liquid temperature, can be further heated to increase the temperature and pressure.

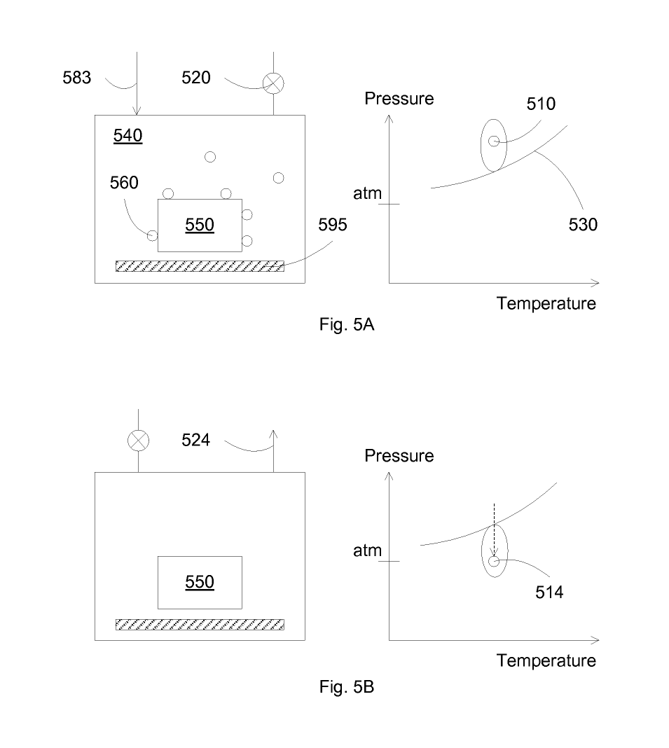

FIGS. 5A-5B illustrate another exemplary cleaning and drying process utilizing hyperbaric vapor pressure according to some embodiments. In FIG. 5A, an object 550 is disposed in a chamber 540, which accepts a high pressure and temperature vapor 560, for example, superheated vapor from a container through conduit 583. Valve 520 is close to maintain high pressure within the chamber 540. The vapor 560 has pressure at or above the boiling pressure corresponded to its liquid temperature, e.g., having temperature-pressure state 510 at or above the boiling curve 530. For example, saturated steam can be at the boiling curve, while superheated steam can have pressure above the boiling curve pressure. An optional heater 595 can be included to heat the chamber, for example, to heat a saturated steam to become a superheated steam. The heater 595 can also be used to heat the chamber walls to reduce or prevent condensation. In addition, the pressure of the vapor 560 is preferably above atmospheric pressure. For example, the vapor 560 can be water vapor, e.g., steam, at pressure 5 bars and temperature 160° C. During the exposure to the high energy vapor 560, the object can be coated with a thin liquid layer, for example, by a condensation process from the vapor. The chamber is shown to be without any liquid, but in some embodiments, liquid can be present.

In FIG. 5B, inlet 583 is close, and valve 520 is quickly open (shown by valve state 524), releasing the vapor 560 to the ambient, e.g., atmospheric environment. The vapor state 514 can be dropped to atmospheric pressure below the boiling curve, and any liquid droplets adhering to the object can be expelled and/or evaporated and released to the ambient. In addition, the expanding vapors can also generate a fluid flow from all surfaces, thus pushing out any liquid droplets trapped inside objects or in-between objects in the chamber, as well as any other liquids in the chamber, especially droplets at the vicinity of the outlet. The pressure release can also carry surface contaminants from the object. The process can be repeated until the object is cleaned.

Other configurations can be used, such as inlet 583 can be coupled to a liquid portion of a high temperature high pressure liquid reservoir, and can be configured to spray a high temperature high pressure liquid (such as a saturated liquid or superheated liquid) on the object 550. The vapor or liquid from inlet 583 can provide a thin liquid coating, either by condensation (from the vapor) or by wetting (from the liquid).

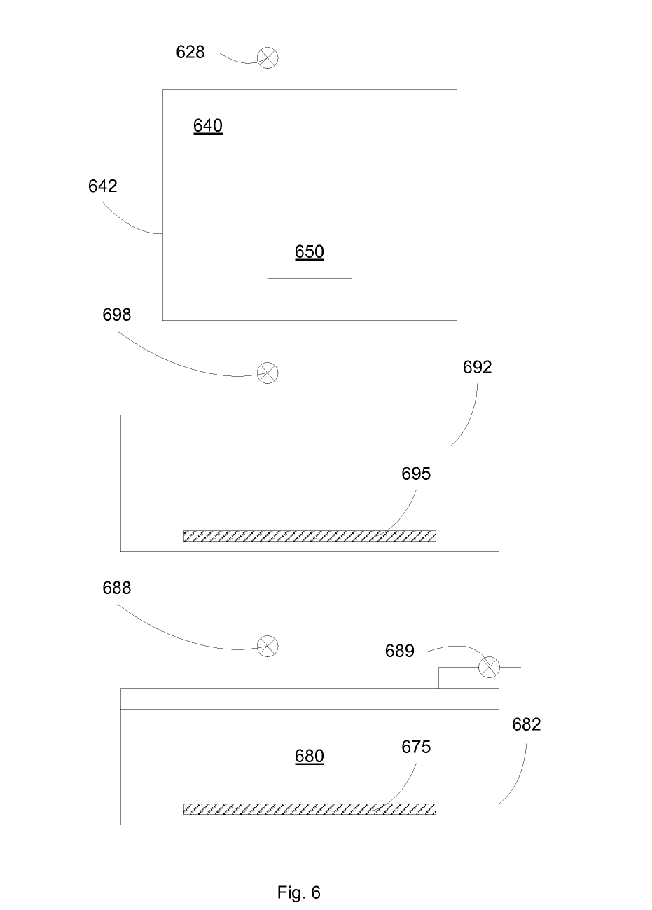

FIG. 6 illustrates another exemplary system configuration for cleaning and/or drying an object according to some embodiments. A reservoir 682 can supply high energy vapor to a another chamber 692 through valve 688 for further heating the vapor through heater 695, for example, turning saturated steam to superheated steam. The superheated steam can then be delivered to chamber 642 through a valve 698. Heater 675 can be used to heat the liquid 680 to a pressure above atmospheric pressure. Heater 675 can be constantly heated to maintain the proper temperature and pressure for the liquid 680. Valve 689 can be used to supply pressurized gas to the reservoir. Valve 688 can be open to deliver the heated vapor to the chamber 642, coating the object 650 within vapor 640. A relief valve 628 is included to release the vapor. Optional heaters can be provided to heat the walls of chamber 640, preventing or reducing condensation on the chamber walls.

Other configurations can be used, such as valve 688 can be coupled to the liquid portion 680, and can be configured to spray a high temperature high pressure liquid (such as a saturated liquid or superheated liquid) on the object 650. The vapor or liquid from inlet 688 can provide a thin liquid coating, either by condensation (from the vapor) or by wetting (from the liquid).

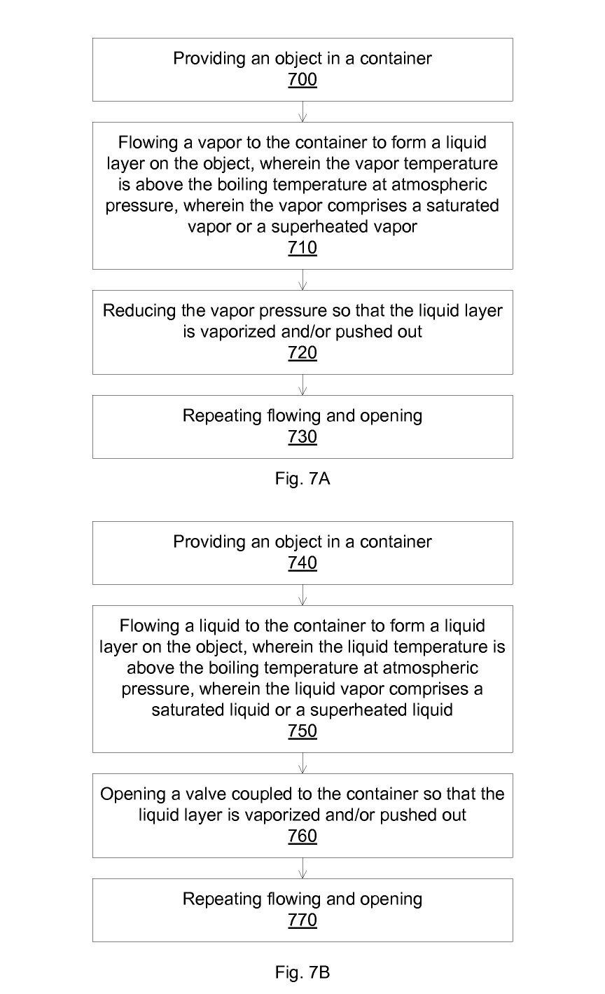

FIGS. 7A-7B illustrate exemplary flow charts for a hyperbaric cleaning process according to some embodiments. In FIG. 7A, operation 700 provides an object in a container, such as a sealed container. The container can be heated, for example, by a heater. External and internal heaters can be used to heat the walls of the container and/or the interior of the container. Operation 710 flows a vapor to the container to form a liquid layer on the object. The liquid layer can be formed by the vapor condensing on the object surface. The liquid layer can include a continuous layer of liquid, or a discontinuous layer having liquid droplet components. The vapor temperature can be above the boiling temperature at atmospheric pressure. The vapor can include a saturated vapor or a superheated vapor. During the opening of the valve, the liquid flow can be stopped or can continue to flow. Operation 720 reduces the vapor pressure in the container so that the liquid layer and/or liquid droplet attached on surfaces of the object is vaporized, and pushed out. The pressure reduction can be stopped.

Operation 730 repeats the process of flowing a vapor and reducing the vapor pressure. In some embodiments, the process can be repeated before or after the vapor is completely evaporated. After the cleaning process, a drying process can be performed, in which the vapor is introduced and completely removed afterward.

In FIG. 7B, operation 740 provides an object in a container. Operation 750 introduces a liquid to the container to form a liquid layer on the object. For example, the liquid can be sprayed on the object. Optional heaters can be used to heat the container walls and/or the gas or vapor inside the container. The liquid temperature can be above the boiling temperature at atmospheric pressure. The liquid can include a saturated vapor or a superheated vapor. Operation 760 opens a valve coupled to the container, either to the vapor portion or to the liquid portion, so that the liquid layer is vaporized and/or pushed out. During the opening of the valve, the liquid can be stopped or can continue to flow. The valve can be close, for example, before repeating the process of introducing the liquid to the container. Operation 770 repeats the process, for example, until the object is cleaned. In some embodiments, the process can be repeated before or after the vapor is completely evaporated. After the cleaning process, a drying process can be performed, in which the vapor is introduced and completely removed afterward.

In some embodiments, the present invention discloses a cleaning and drying process, using hyperbaric liquid and vapor. For example, a hyperbaric liquid (e.g., liquid at high temperature and pressure such as saturated water) can be used for cleaning, such as by spraying liquid on the object, followed by evaporation and expulsion of liquid layer or droplets from the object surfaces. Then a hyperbaric vapor (e.g., vapor at high temperature and pressure, such as saturated or superheated steam) can be used for drying, such as by evaporation and expulsion of liquid droplets from surfaces.

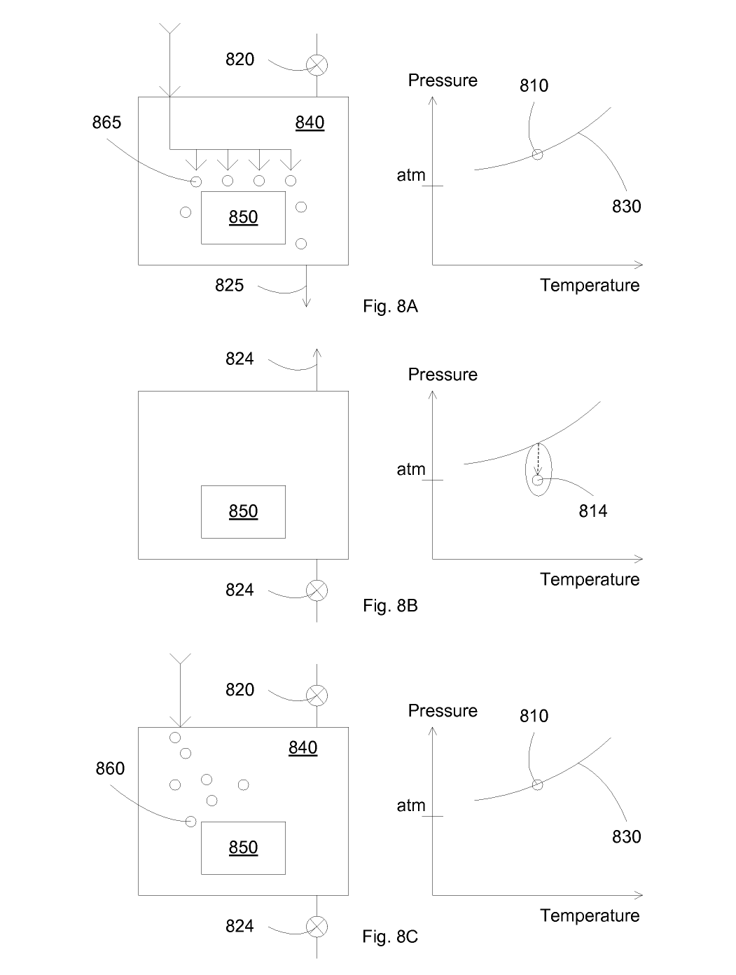

FIGS. 8A-8C illustrate an exemplary cleaning and drying process utilizing hyperbaric vapor pressure according to some embodiments. In FIG. 8A, an object 850 is disposed in a chamber 840, which accepts a high pressure and temperature liquid 865, for example, by spraying on the object to form a liquid layer or liquid droplet coating. Valve 820 is close to maintain high pressure within the chamber 840. The liquid 865 has pressure at or above the boiling pressure corresponded to its liquid temperature, e.g., having temperature-pressure state 810 at or above the boiling curve 830. For example, saturated liquid can be at the boiling curve, while superheated liquid can have pressure above the boiling curve pressure. In addition, the pressure of the chamber 840 is preferably above atmospheric pressure.

In FIG. 8B, valve 820 is quickly open (shown by valve state 824), reducing the pressure in the chamber 840 and releasing the vapor 865 to the ambient, e.g., atmospheric environment. The vapor state 814 can be dropped to atmospheric pressure below the boiling curve, and the liquid layer of liquid droplets coating the object can be evaporated and released to the ambient. The evaporation can also extract contaminants from the object surfaces, thus can perform a cleaning process on the object.

The process can be repeated to clean the object, for example, by a cyclic spraying -evaporating process with cycling pressure in the chamber. Excess liquid can be drained, for example, through conduit 825.

In FIG. 8C, any remaining liquid can be drained, and drain valve 824 is closed. High pressure and high temperature vapor can be introduced to the chamber 840, forming high energy vapor 860 on the object, such as a liquid layer or a liquid droplet coating. The pressure can be released, for example, by opening valve 820 as discussed above. The process can be repeated to clean or dry the object.

In some embodiments, the pressure release can provide an effective drying of the object, since the liquid vapor can be quickly evaporated when returning to atmospheric pressure, and liquid droplets can be expelled from surfaces and trapped spaces and pushed out of the chamber.

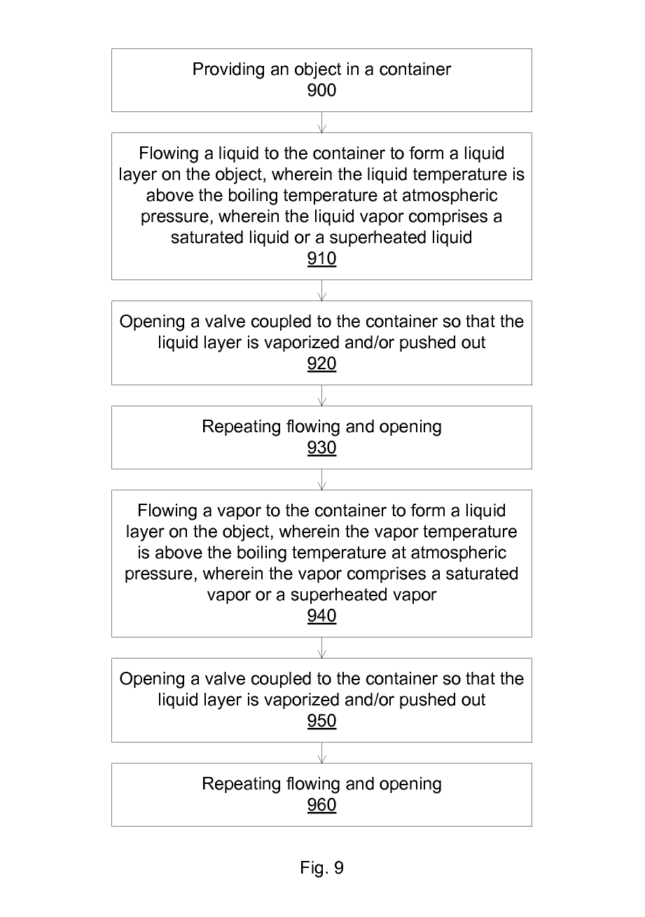

FIG. 9 illustrates another exemplary flow chart for a hyperbaric drying process according to some embodiments. Operation 900 provides an object in a container. Operation 910 introduces a liquid to the container to form a liquid layer on the object. For example, the liquid can be sprayed on the object. Optional heaters can be used to heat the container walls and/or the gas or vapor inside the container. The liquid temperature can be above the boiling temperature at atmospheric pressure. The liquid can include a saturated vapor or a superheated vapor. Operation 920 opens a valve coupled to the container, either to the vapor portion or to the liquid portion, so that the liquid layer is vaporized and/or pushed out. During the opening of the valve, the liquid can be stopped or can continue to flow. The valve can be close, for example, before repeating the process of introducing the liquid to the container. Operation 930 repeats the process, for example, until the object is cleaned. In some embodiments, the process can be repeated before or after the vapor is completely evaporated.

Operation 940 flows a vapor to the container to form a liquid layer on the object. The liquid layer can be formed by the vapor condensing on the object surface. The liquid layer can include a continuous layer of liquid, or a discontinuous layer having liquid droplet components. The vapor temperature can be above the boiling temperature at atmospheric pressure. The vapor can include a saturated vapor or a superheated vapor. During the opening of the valve, the liquid flow can be stopped or can continue to flow. Operation 950 reduces the vapor pressure in the container so that the liquid layer and/or liquid droplet attached on surfaces of the object is vaporized, and pushed out. The pressure reduction can be stopped. Operation 960 repeats the process, for example, until the object is cleaned. After the cleaning process, a drying process can be performed, in which the vapor is introduced and completely removed afterward.

In some embodiments, a Vacuum Condenser Pressure Release Container (VCPRC) can be used to recycle the hot vapor. A VCPRC can include a condenser coil, such as a conduit line filled with circulating cooling fluid. The condenser coil can include any assembly that can condense a vapor to a liquid phase. The VCPRC can include an optional drain valve to drain any condensed liquid. The VCPRC can include an optional gas escape valve to release the gas within the VCPRC. The VCPRC can include an optional coupling conduit to allow coupling to a hyperbaric chamber, The coupling conduit can include an isolation assembly, such as a valve to connect to or disconnect the hyperbaric chamber from the VCPRC.

The vapor released from the chamber during the hyperbaric process can be released to a VCPRC. The advantages of using a VCPRC are several: The high pressure vapors released have considerable heat and energy and containment of the hot vapors addresses safety concerns. Also, since the vapors trapped in the VCPRC can be condensed to liquid by means of external cooling, the pressure in the VCPRC will reach vacuum levels as the vapors condense to liquid. This will increase the potential pressure drop achievable in the CNX process. Furthermore, since the liquid medium may be an expensive or environmentally unfriendly chemical, the condensed vapors are easily contained for proper disposal or recycling.

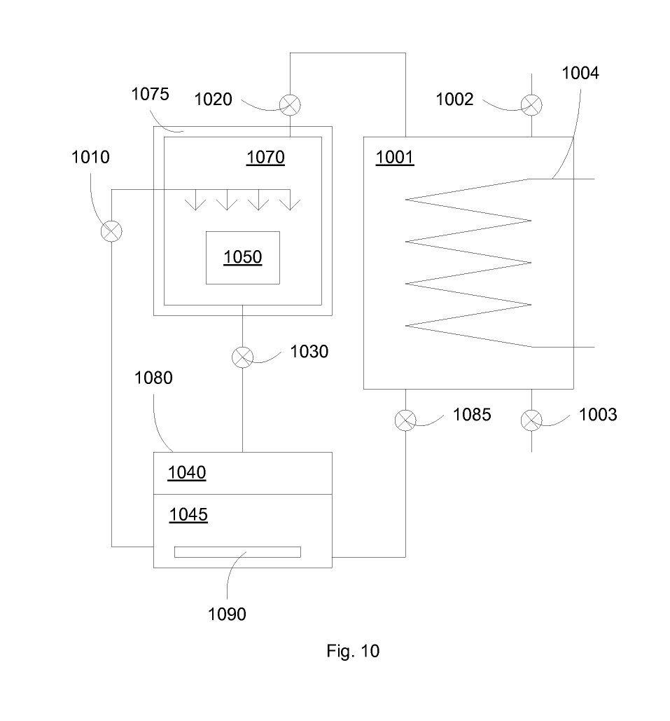

FIG. 10 illustrates a schematic layout of a thin liquid hyperbaric system according to some embodiments. An object 1050 can be placed in a sealed process chamber 1070 that can be insulated 1075 or actively heated to minimize wetting of chamber walls. The chamber 1070 is connected to the vapor/liquid supply reservoir 1080 which may contain a heating element 1090 which is used to heat the liquid 1045 preferably above its boiling temperature and above atmospheric pressure. The headspace above the liquid is filled with saturated vapor 1040 above atmospheric pressure. The chamber 1070 also is connected to an outlet through a relief valve 1020. The outlet can optionally connected to a vacuum condenser pressure relief container (VCPRC) 1001 which can condense the escaping vapors and collect the condensate for re-use or disposal.

The VCPRC 1001 can include a condenser coil 1004, which can act as a heat exchanger to condense the heated vapor introduced to the VCPRC 1001 from the process chamber 1070, for example, through valve 1020. A relief valve 1002 can be coupled to the VCPRC 1001, for example, to release excessive pressure. A drain valve 1003 can be coupled to the VCPRC 1001, for example, to drain any collected liquid in the VCPRC 1001. Alternatively, the collected liquid in the VCPRC 1001 can be returned to the reservoir 1080 for re-use, for example, through valve 1085.

The supply reservoir 1080 can be configured to supply saturated vapor 1040 to the process chamber 1070 through a vapor supply valve 1030. Alternatively, or concurrently, the supply reservoir 1080 can be configured to supply saturated liquid 1045 to the process chamber, for example, in a spray configuration through liquid supply valve 1010. Thus the supply reservoir can supply vapor, liquid, or both vapor and liquid to the process chamber to form a thin liquid layer on the object surface.

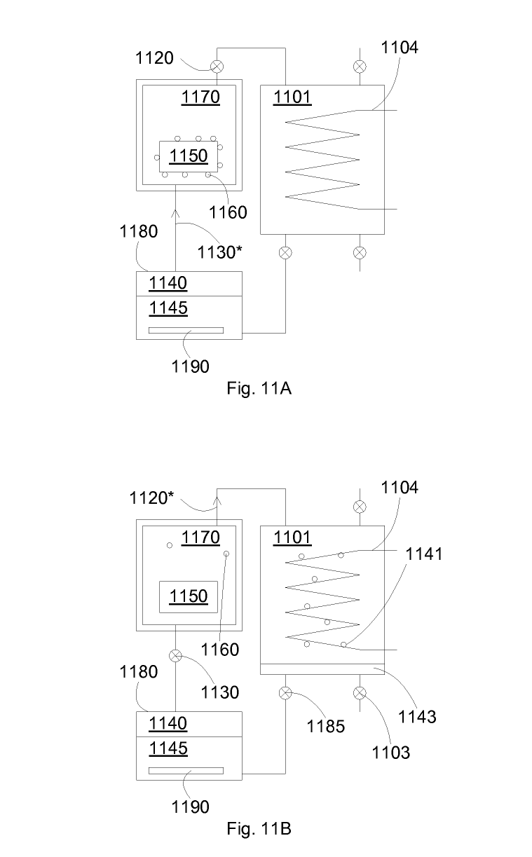

FIGS. 11A-11B illustrate a hyperbaric cleaning process according to some embodiments. A hyperbaric system can include a heated and insulated process chamber 1170, which is coupled to a vapor/liquid supply reservoir 1180. The reservoir 1180 can contain a saturated liquid 1145/saturated vapor 1140, heated by a heating element 1190. A relief valve 1120 can be coupled to the process chamber 1170, coupling the process chamber 1170 with a drain reservoir 1101. The drain reservoir 1101 can be configured to condense the escaping vapors and collect the condensate for re-use or disposal.

FIG. 11A shows phase 1 of the hyperbaric cleaning process, including introducing the vapor to the process chamber. An object 1150 can be placed in the process chamber 1170. Vapor delivery valve 1130 is opened (indicated by arrow 1130*) and high pressure vapor 1140 from the supply reservoir 1180 is allowed to fill the chamber. Since the chamber 1170 has heated walls, condensation of the saturated vapor 60 will be driven to form on the unheated object. A thin liquid layer 1160 or a layer of liquid droplets can be formed on the object 1150. The thin liquid on the object may be chemically active to provide various controlled surface treatment and/or cleaning processes. The chemical active liquid can include hydrogen peroxide, oxidants, acid or base chemicals.

FIG. 11B shows phase 2 of the hyperbaric cleaning process, including a rapid pressure release of the process chamber 1170 as the relief valve 1120 is opened (indicated by arrow 1120*). Vapor 1160 escapes the chamber rapidly and as the pressure drops, the thin liquid 1160 on the object flashes to vapor, carrying with it unwanted residue from the object.

Valve 1130 can be close before valve 1120 is open. Alternatively, valve 1130 can be close after valve 1120 is open, or valve 1130 can remain open when valve 1120 is open.

The drain reservoir 1101 can remove vapor from the chamber and the expanded and cooled vapor 1141 also begins to condense on the cooling coils 1104 and collect at the bottom of the tank 1143.

In some embodiments, drain valve 1103 can be open to drain the collected liquid 1143 from the drain reservoir 1101. Alternatively, the collected liquid 1143 can be recycled to the supply reservoir through the open valve 1185. For example, the saturated vapor 1142 in the drain reservoir 1101 can be cooled enough to change phase, e.g., becoming a saturated liquid 1143 without or with minimum temperature loss. Thus the saturated liquid 1143 can be recycled to the supply reservoir 1180 with minimum energy loss.

After the vapor has escaped from the chamber, the valve 1120 can be closed, ready for phase 1 of a next pressure relief cycle. The process can continue, e.g., phase 1 and phase 2 are repeated, until the object cleaned.

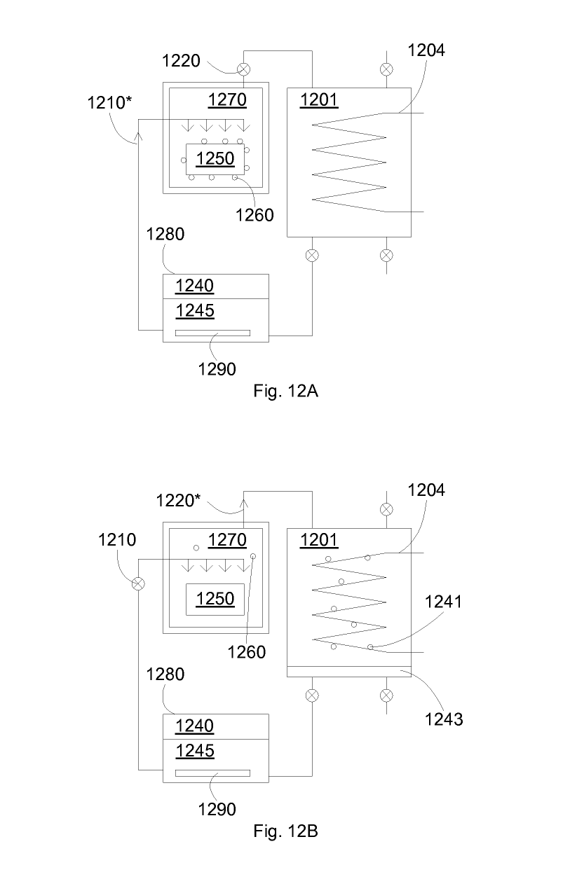

FIGS. 12A-12B illustrate a hyperbaric cleaning process according to some embodiments. A hyperbaric system can include a heated and insulated process chamber 1270, which is coupled to a vapor/liquid supply reservoir 1280. The reservoir 1280 can contain a saturated liquid 1245/saturated vapor 1240, heated by a heating element 1290. A relief valve 1220 can be coupled to the process chamber 1270, coupling the process chamber 1270 with a drain reservoir 1201. The drain reservoir 1201 can be configured to condense the escaping vapors and collect the condensate for re-use or disposal.

FIG. 12A shows phase 1 of the hyperbaric cleaning process, including introducing the liquid to the process chamber. An object 1250 can be placed in the process chamber 1270. Liquid delivery valve 1210 is opened (indicated by arrow 1210*) and high pressure liquid 1245 from the supply reservoir 1280 is sprayed on the object. A thin liquid layer 1260 or a layer of liquid droplets can be formed on the object 1250.

FIG. 12B shows phase 2 of the hyperbaric cleaning process, including a rapid pressure release of the process chamber 1270 as the relief valve 1220 is opened (indicated by arrow 1220*). Vapor 1260 escapes the chamber rapidly and as the pressure drops, the thin liquid 1260 on the object flashes to vapor, carrying with it unwanted residue from the object.

Valve 1210 can be close before valve 1220 is open. Alternatively, valve 1210 can be close after valve 1220 is open, or valve 1210 can remain open when valve 1220 is open.

The drain reservoir 1201 can remove vapor from the chamber and the expanded and cooled vapor 1241 also begins to condense on the cooling coils 1204 and collect at the bottom of the tank 1243.

After the vapor has escaped from the chamber, the valve 1220 can be closed, ready for phase 1 of a next pressure relief cycle. The process can continue, e.g., phase 1 and phase 2 are repeated, until the object cleaned.

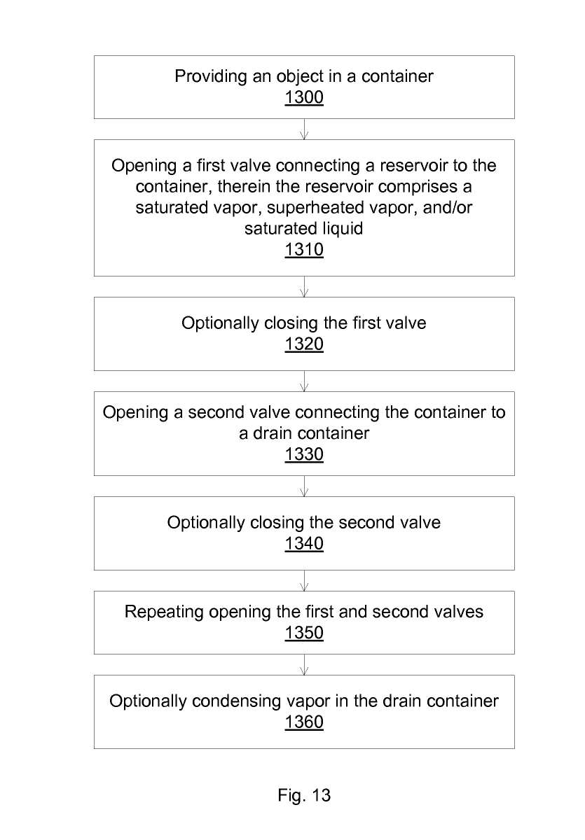

FIG. 13 illustrates a flow chart for a hyperbaric cleaning process according to some embodiments. Operation 1300 provides an object in a container, such as a sealed container. The container can be heated, for example, by a heater. External and internal heaters can be used to heat the walls of the container and/or the interior of the container. The container can also be insulated. Operation 1310 opens a first valve. The first valve is configured to connect the container to a supply reservoir. The reservoir can contain at least one of saturated vapor, a superheated vapor, and a saturated liquid. For example, the supply reservoir can contain a saturated liquid and saturated vapor, caused by heating a liquid in the reservoir to a temperature and pressure above the evaporation temperature of the liquid. The reservoir can contain a superheated vapor, caused by heating a saturated vapor, which is supplied to the reservoir from another container having saturated liquid and vapor.

Opening the first valve can allow the vapor in the reservoir to flow to the container. The vapor can condense on the object, forming a liquid layer on the object. The liquid layer can include a continuous layer of liquid, or a discontinuous layer having liquid droplet components.

Operation 1320 optionally closes the first valve. Operation 1330 opens a second valve. The second valve is configured to connect the container to a drain reservoir or to the ambient. Opening the second valve can reduce the vapor pressure in the container so that the liquid layer and/or liquid droplet attached on surfaces of the object is vaporized, and pushed out. Operation 1340 optionally closes the second valve.

Operation 1350 repeats the process of opening the first and second valves, for example, until the object is cleaned and dried.

Operation 1360 optionally condenses vapor in the drain container.

What is claimed is:

1. A method comprising
providing an object in a chamber;
condensing a saturated vapor or a superheated vapor on the object to form a liquid layer;
wherein the saturated vapor or the superheated vapor has a temperature above the boiling temperature at atmospheric pressure;
evaporating the liquid layer;
repeating condensing and evaporating.

2. A method as in claim 1 wherein the superheated vapor comprises superheated steam.

3. A method as in claim 1 wherein the chamber is heated externally.

4. A method as in claim 1 wherein the temperature of the saturated vapor or the superheated vapor is between 110 and 200 C, wherein the pressure of the saturated vapor or the superheated vapor is between 1 and 20 bars.

5. A method as in claim 1 wherein the saturated vapor or the superheated vapor comprises the vapor of a chemical active liquid.

6. A method as in claim 1 wherein the saturated vapor or the superheated vapor is supplied from a reservoir, wherein the reservoir comprises a reservoir liquid and a reservoir heater to heat the reservoir liquid to a saturated state.

7. A method as in claim 1 wherein the saturated vapor or the superheated vapor is supplied from a reservoir, wherein the reservoir comprises a reservoir vapor and a reservoir heater to heat the reservoir vapor to a superheated state.

8. A method as in claim 1 wherein the liquid layer is evaporated due to a pressure drop in the chamber.

9. A method comprising
providing an object in a chamber;
spraying a saturated liquid on the object to form a liquid layer;
wherein the saturated liquid has a temperature above the boiling temperature at atmospheric pressure;
evaporating the liquid layer;
repeating condensing and evaporating.

10. A method as in claim 9 wherein the temperature of the saturated liquid is between 110 and 200 C, wherein the pressure of the vapor of the saturated liquid is between 1 and 20 bars.

11. A method as in claim 9 wherein the saturated liquid comprises a chemical active liquid.

12. A method as in claim 9 wherein the saturated liquid is supplied from a reservoir, wherein the reservoir comprises a reservoir liquid and a reservoir heater to heat the reservoir liquid to a saturated state.

13. A method as in claim 9 wherein the liquid layer is evaporated due to a pressure drop in the chamber.

14. A method as in claim 9 further comprising
drying the object by a cycling of condensing a saturated vapor or a superheated vapor on the object, followed by evaporating the condensed vapor.

15. A method comprising
providing an object in a chamber;
opening a first valve coupled to the chamber to introduce a fluid to the chamber,
wherein the fluid comprises at least one of a saturated vapor, a superheated vapor, and a saturated liquid,
wherein the fluid is operable to form a liquid layer on the object,
wherein the fluid has a temperature above the boiling temperature at atmospheric pressure;
opening a second valve coupled to the chamber to evaporate the liquid layer;
repeating condensing and evaporating.

16. A method as in claim 15 wherein the temperature of the fluid is between 110 and 200 C, wherein the pressure of the vapor of the fluid is between 1 and 20 bars.

17. A method as in claim 15 wherein the fluid comprises a chemical active liquid.

18. A method as in claim 15 wherein the fluid is supplied from a reservoir, wherein the reservoir comprises a reservoir liquid and a reservoir heater to heat the reservoir liquid to a saturated state.

19. A method as in claim 15 wherein the fluid is supplied from a reservoir, wherein the reservoir comprises a reservoir vapor and a reservoir heater to heat the reservoir vapor to a superheated state.

20. A method as in claim 15 wherein the liquid layer is evaporated due to a pressure drop in the chamber.
